(19) United States
(12) Patent Application Publication
(10) Pub. No.: US 2021/0131409 A1
(43) Pub. Date: May 6, 2021

(54) SINGLE-MOTOR SINGLE-PUMP ELECTRIC DRIVE FRACTURING SEMI-TRAILER

(71) Applicant: YANTAI JEREH PETROLEUM EQUIPMENT & TECHNOLOGIES CO., LTD., Yantai (CN)

(72) Inventors: Shuzhen Cui, Yantai (CN); Rikui Zhang, Yantai (CN); Sheng Chang, Yantai (CN)

(21) Appl. No.: 16/832,872

(22) Filed: Mar. 27, 2020

(30) Foreign Application Priority Data
Oct. 30, 2019 (CN) 201911044083.3

(51) Int. Cl. F04B 17/03; F04B 53/08; F04B 53/18; F04B 53/00; E21B 43/26

(52) U.S. Cl. CPC F04B 17/03; F04B 53/08; E21B 43/2607; F04B 53/006; F04B 53/18

(57) ABSTRACT

The present invention discloses a single-motor single-pump electric drive fracturing semi-trailer, which optimally merge a traditional power supply semi-trailer and a fracturing semi-trailer together to realize the function of a semi-trailer for supplying power and fracturing simultaneously, without the need of using a power supply semi-trailer and a fracturing semi-trailer as a complete set, making it more flexible in practical uses, greatly optimizing the wellsite arrangement in oil and gas fields and facilitating the transportation; only one set of high voltage cable is need to connect to a high voltage power supply to reach working state, the wiring installation is more faster; compared with diesel-driven fracturing, electric drive fracturing generates low noise and no waste emission pollution; driven by electricity, it is cheaper to use than diesel.

### TECHNICAL FIELD

The present invention relates to the technical field of electric drive fracturing equipment, and specifically to a single-motor single-pump electric drive fracturing semi-trailer.

### BACKGROUND

In the working sites of fracturing in oil and gas fields all over the world, the power driving modes for plunger pumps mainly include the following two ways:

One driving mode is that a diesel engine is connected to a transmission to drive the fracturing plunger pump through a transmission shaft to work. In other words, a diesel engine is used as the power source, a transmission and a transmission shaft are used as the transmission devices, and a plunger pump is used as the actuating element.

This configuration mode has the following disadvantages:

(1) Large volume and heavy weight: When a diesel engine drives a transmission to drive a plunger pump through a transmission shaft, a large volume is occupied, a heavy weight is involved, the transportation is restricted, and the power density is low;

(2) Environmental problems: During operations on a well site, the fracturing equipment driven by the diesel engine would generate engine waste gas pollution and noise pollution. The noise exceeding 105 dBA will severely affect the normal life of nearby residents;

(3) Cost inefficiency: The fracturing equipment driven by the diesel engine requires relatively high initial purchase costs and incurs high fuel consumption costs for unit power during operation, and the engine and the transmission also require very high routine maintenance costs.

The other driving mode is that an electric motor is connected to a transmission shaft or a coupling to drive the plunger pump to work. In other words, an electric motor is used as the power source, a transmission shaft or a coupling is used as the transmission device, and a plunger pump is used as the actuating element, i.e, electric drive fracturing.

Electric drive fracturing equipment is relatively widely used in some places with complete power facilities. The existing electric drive fracturing equipment is usually provided with special power supply equipment to provide the driving power. The power supply equipment and the electric drive fracturing equipment are usually arranged one-to-one, or one high-power power supply equipment is used to drive several electric drive fracturing equipment (hereinafter referred to as one-to-many). However, no matter one-to-one or one-to-many, in the practical use of a well site, it takes too much time to arrange the electric drive fracturing equipment and the power supply equipment (i.e, electric drive fracturing equipment and power supply equipment should be used in complete sets); furthermore, each electric drive fracturing equipment should be connected to the power supply equipment, so that the electric drive fracturing equipment could enter working state; the above processes are all time and labor consuming, and there are also too many connection wires between equipment, and it seems relatively cumbersome.

Therefore, there is an urgent need for an economical and environmentally friendly electric drive fracturing equipment with small volume and simple connection.

### SUMMARY

To overcome the deficiencies in the prior art, an objective of the present invention is to provide a single-motor single-pump electric drive fracturing semi-trailer, which optimally merge a traditional power supply semi-trailer and a fracturing semi-trailer together to realize the function of a semi-trailer for supplying power and fracturing simultaneously, without the need of using a power supply semi-trailer and a fracturing semi-trailer as a complete set, making it more flexible in practical uses, greatly optimizing the wellsite arrangement in oil and gas fields and facilitating the transportation; only one set of high voltage cable is need to connect to a high voltage power supply to reach working state, the wiring installation is more faster; compared with diesel-driven fracturing, electric drive fracturing generates low noise and no waste emission pollution; driven by electricity, it is cheaper to use than diesel. A five cylinder plunger pump of 5000 hp or above, especially 7000 hp, is employed to greatly enhance the output power of the single-motor single-pump electric drive fracturing semi-trailer of the invention, and in the context of high output power of single-semi-trailer, the wellsite power density per unit area is also greatly enhanced. The power end housing of the five cylinder plunger pump adopts an integral welding structure, so that the power end assembly has a higher structural strength and a better support stability to reduce vibration of the whole pump. The cylinder spacing of the five cylinder plunger pump is 13-14 inches, ensuring the high-power output of the five cylinder plunger pump. The high-power five cylinder plunger pump can effectively solve the problems of narrow area and many fracturing equipment being required in shale gas fracturing wellsite, thus reducing the use of equipment and facilitating the arrangement of the wellsite. The multi-point support design of the crankcase, the crosshead case and the hydraulic end assembly can enhance the support strength of the five cylinder plunger pump and reduce the vibration, thus better ensuring high load operation and more smoothly running.

The objective of the present invention is achieved by the following technical measures: A single-motor single-pump electric drive fracturing semi-trailer, including a semi-trailer body, a plunger pump, a radiator, a power supply unit and an electric motor, wherein the power supply unit, the electric motor, the radiator and the plunger pump are integrated on the semi-trailer body, there are one electric motor, one radiator, and one plunger pump, the power supply unit provides power for the electric motor, the electric motor is connected to the plunger pump, the radiator cools the lubricating oil of the plunger pump.

Further, the power supply unit includes a voltage conversion unit and a frequency conversion unit. The frequency conversion unit is connected to the voltage conversion unit, the voltage conversion unit is disposed at one end of the semi-trailer body near the electric motor, and the frequency conversion unit is disposed on a gooseneck of the semi-trailer body.

Further, the voltage conversion unit has a compartment structure provided with a high voltage switch and a transformer therein. The high voltage switch is connected to the transformer.

Further, the frequency conversion unit has a compartment structure provided with a frequency converter therein. An input end of the frequency converter is connected to the voltage conversion unit, and an output end of the frequency converter is connected to the electric motor.

Further, the plunger pump is a five cylinder plunger pump which includes a power end assembly, a hydraulic end assembly and a reduction gearbox assembly. One end of the power end assembly is connected to the hydraulic end assembly, and the other end of the power end assembly is connected to the reduction gearbox assembly. The power end assembly includes a crankcase, a crosshead case and a spacer frame which are connected in sequence.

Further, the stroke of the five cylinder plunger pump is 10″ or above.

Further, the power of the five cylinder plunger pump is 5000 hp or above.

Further, the power of the five cylinder plunger pump is 7000 hp.

Further, the cylinder spacing of the five cylinder plunger pump is 13-14 inches.

Further, the crankcase and the crosshead case are integrally welded to constitute a power end housing which is connected to the spacer frame, the power end housing includes a vertical plate, a bearing seat, a front end plate, a back cover plate, a base plate, a support plate and an upper cover plate; there are six vertical plates and six bearing seats, each vertical plate is connected to a corresponding bearing seat, and the six vertical plates are arranged in parallel to constitute a power end chamber; the base plate is mounted at the bottom of the power end chamber, and the upper cover plate is mounted on the top of the power end chamber, the front end plate is mounted at the front end of the power end chamber, the back cover plate is mounted at the back end of the power end chamber, and the support plate is disposed between two adjacent vertical plates arranged in parallel.

Further, a crankshaft support is disposed at the bottom of the crankcase, and the crankshaft support is used to support the crankcase.

Further, a crosshead support is disposed at the bottom of the crosshead case, and the crosshead support is used to support the crosshead case.

Further, a hydraulic support is disposed at the bottom of the spacer frame, and the hydraulic support is used to support the hydraulic end assembly.

Compared with the prior art, the beneficial effects of the present invention are as follows: a traditional power supply semi-trailer and a fracturing semi-trailer are optimally merged together to realize the function of a semi-trailer for supplying power and fracturing simultaneously, without the need of using a power supply semi-trailer and a fracturing semi-trailer as a complete set, making it more flexible in practical uses, greatly optimizing the wellsite arrangement in oil and gas fields and facilitating the transportation; only one set of high voltage cable is need to connect to a high voltage power supply to reach working state, the wiring installation is more faster; compared with diesel-driven fracturing, electric drive fracturing generates low noise and no waste emission pollution; driven by electricity, it is cheaper to use than diesel. A five cylinder plunger pump of 5000 hp or above, especially 7000 hp, is employed to greatly enhance the output power of the single-motor single-pump electric drive fracturing semi-trailer of the invention, and in the context of high output power of single-semi-trailer, the wellsite power density per unit area is also greatly enhanced. The power end housing of the five cylinder plunger pump adopts an integral welding structure, so that the power end assembly has a higher structural strength and a better support stability to reduce vibration of the whole pump. The cylinder spacing of the five cylinder plunger pump is 13-14 inches, ensuring the high-power output of the five cylinder plunger pump. The high-power five cylinder plunger pump can effectively solve the problems of narrow area and many fracturing equipment being required in shale gas fracturing wellsite, thus reducing the use of equipment and facilitating the arrangement of the wellsite. The multi-point support design of the crankcase, the crosshead case and the hydraulic end assembly can enhance the support strength of the five cylinder plunger pump and reduce the vibration, thus better ensuring high load operation and more smoothly running.

The present invention will be described in detail below with reference to the accompanying drawings and specific implementations.

### BRIEF DESCRIPTION OF THE DRAWINGS

FIG. 1 is a schematic structural diagram of a single-motor single-pump electric drive fracturing semi-trailer.

FIG. 2 is a schematic structural diagram of a five cylinder plunger pump.

FIG. 3 is a schematic structural diagram of a power end housing.

Wherein, 1. semi-trailer body, 2. frequency conversion unit, 3. voltage conversion unit, 4. electric motor, 5. plunger pump, 6. radiator, 7. power end assembly, 8. reduction gearbox assembly, 9. hydraulic end assembly, 10. driving flange, 11. power end housing, 12. crankshaft support, 13. crosshead support, 14. hydraulic support, 15. back cover plate, 16. vertical plate, 17. bearing seat, 18. base plate, 19. support plate, 20. front end plate, and 21. upper cover plate.

### DESCRIPTION OF THE EMBODIMENTS

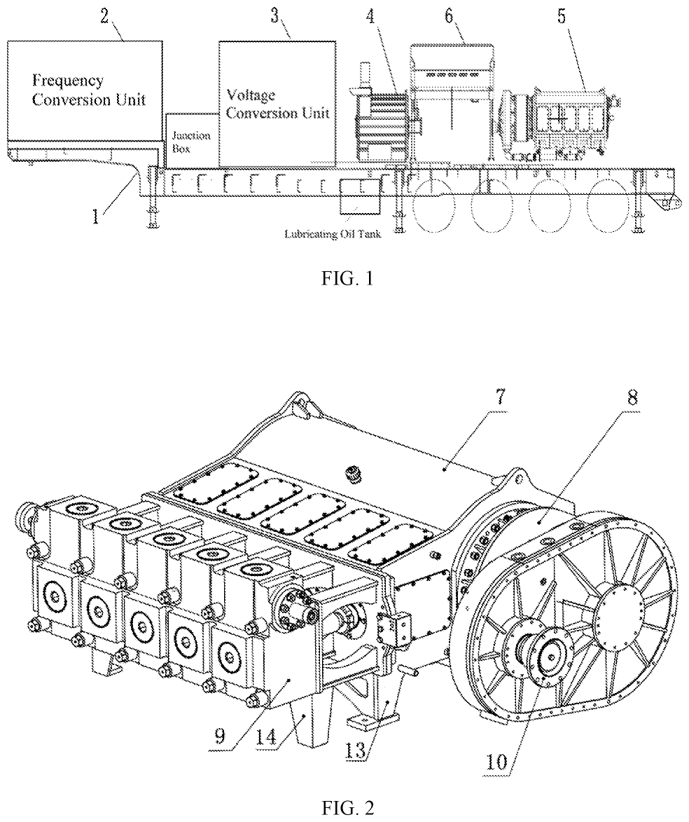

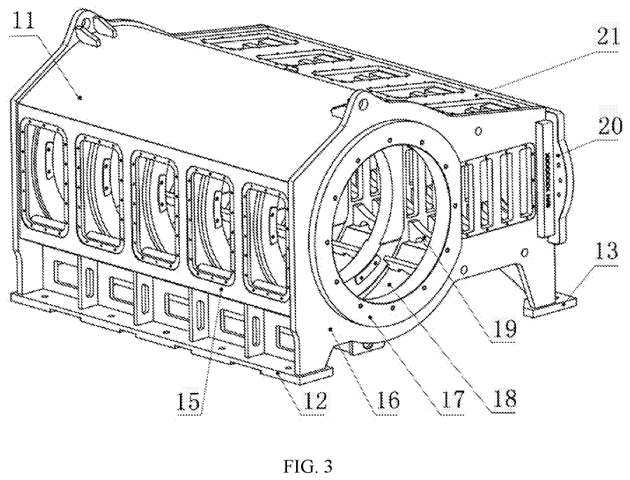

As shown in FIGS. 1 to 3, an embodiment provides a single-motor single-pump electric drive fracturing semi-trailer, including a semi-trailer body 1, a plunger pump 5, a radiator 6, a power supply unit and an electric motor 4, wherein the power supply unit, the electric motor 4, the radiator 6 and the plunger pump 5 are integrated on the semi-trailer body 1, there are one electric motor 4, one radiator 6, and one plunger pump 5, the power supply unit provides power for the electric motor 4, the electric motor 4 is connected to the plunger pump 5, and the radiator 6 cools the lubricating oil of the plunger pump 5. The power supply unit includes a voltage conversion unit 3 and a frequency conversion unit 2, the frequency conversion unit 2 is connected to the voltage conversion unit 3, the voltage conversion unit 3 is disposed at one end of the semi-trailer body 1 near the electric motor 4, and the frequency conversion unit 2 is disposed on a gooseneck of the semi-trailer body 1. The number of axles of the semi-trailer body 1 is 4. The semi-trailer is further provided with an electrical control cabinet to implement local manipulation of the semi-trailer. A traditional power supply semi-trailer and a fracturing semi-trailer are optimally merged together to realize the function of a semi-trailer for supplying power and fracturing simultaneously. Compared to that the existing power supply semi-trailer and a fracturing semi-trailer are used as a complete set, (for example, when one power supply semi-trailer is used to drive multiple fracturing semi-trailers, wiring is relatively tedious, there would be a lot of wiring accumulation and intricate lines in the field, and it may take up a lot of time on the arrangements of every power supply semi-trailer and multiple fracturing semi-trailers), in field uses, the power supply semi-trailer and the fracturing semi-trailer are separately transported, moved, and then wired and installed. The single-motor single-pump electric drive fracturing semi-trailer of the invention only need to be moved once, and it can be connected to a high voltage power supply only through a set of high voltage cable to reach working state. Compared with diesel-driven fracturing, electric drive fracturing generates low noise and no waste emission pollution; driven by electricity, it is cheaper to use than diesel.

The voltage conversion unit 3 has a compartment structure provided with a high voltage switch and a transformer therein, the high voltage switch is connected to the transformer. The frequency conversion unit 2 has a compartment structure provided with a frequency converter therein, an input end of the frequency converter is connected to the voltage conversion unit 3, specifically, the input end of the frequency converter is connected to the transformer, and an output end of the frequency converter is connected to the electric motor 4.

The plunger pump 5 is a five cylinder plunger pump which includes a power end assembly 7, a hydraulic end assembly 9 and a reduction gearbox assembly 8, one end of the power end assembly 7 is connected to the hydraulic end assembly 9, the other end of the power end assembly 7 is connected to the reduction gearbox assembly 8, the power end assembly 7 includes a crankcase, a crosshead case and a spacer frame which are connected in sequence.

The stroke of the five cylinder plunger pump is 10″ or above. The design of long stroke is beneficial to realize the operation requirement of large displacement and enhance the operation efficiency.

The power of the five cylinder plunger pump is 5000 hp or above. More preferably, the power of the five cylinder plunger pump is 7000 hp. The cylinder spacing of the five cylinder plunger pump is 13-14 inches, ensuring the high-power output of the five cylinder plunger pump. The high-power five cylinder plunger pump can effectively solve the problems of narrow area and many fracturing equipment being required in shale gas fracturing wellsite, thus reducing the use of equipment and facilitating the arrangement of the wellsite.

The crankcase and the crosshead case are integrally welded to constitute a power end housing 11 which is connected to the spacer frame, the power end housing 11 includes a vertical plate 16, a bearing seat 17, a front end plate 20, a back cover plate 15, a base plate 18, a support plate 19 and an upper cover plate 21; there are six vertical plates 16 and six bearing seats 17, each vertical plate 16 is connected to a corresponding bearing seat 17, and the six vertical plates 16 are arranged in parallel to constitute a power end chamber; the base plate 18 is mounted at the bottom of the power end chamber, the upper cover plate 21 is mounted on the top of the power end chamber, the front end plate 20 is mounted at the front end of the power end chamber, and the back cover plate 15 is mounted at the back end of the power end chamber; and the support plate 19 is disposed between two adjacent vertical plates 16 arranged in parallel. The crankcase and the crosshead case in the power end assembly 7 of the five cylinder plunger pump are integrally welded so that the power end assembly 7 has a higher structural strength and a better support stability to reduce vibration of the whole pump. A crankshaft is disposed in the crankcase. A crosshead, a crosshead cap and a crosshead bearing bush are disposed in the crosshead case. A connecting rod, a connecting rod cap and a connecting rod bearing bush are disposed between the crankcase and the crosshead case. The crankshaft adopts a setting of five-crank and six-journal. One end of the crankshaft is connected to the reduction gearbox assembly 8, the other end of the crankshaft is connected to the connecting rod through a connecting rod cap and a connecting rod bearing bush, the other end of the connecting rod is connected to the crosshead through a crosshead cap and a crosshead bearing bush, the other end of the crosshead is connected with a pull rod, and the other end of the pull rod is connected to a hydraulic end valve housing through a plunger and a clamp. The crankshaft is mounted on the bearing seat 17 of the power end housing 11 through six cylindrical roller bearings to allow the crankshaft rotation. The support plate 19 is fixedly installed with two slide rails to form a semi-circular space. A crosshead is mounted within the semi-circular space to allow linear motion. The reduction gearbox assembly 8 includes a planetary reduction gearbox and a parallel reduction gearbox, the transmission gears of which are all bevel gears. The planetary reduction gearbox includes a sun gear, four planetary gears, a planetary carrier and an inner gear ring, constituting a planetary gear mechanism, with the sun gear at the center of the planetary gear mechanism; the parallel reduction gearbox includes a pinion and a bull gear, the pinion is connected to an input end, the bull gear is connected to a sun gear of the planetary reduction gearbox. A reduction gearbox is used to slow down and increase the torque. A driving flange 10 is disposed outside the planetary reduction gearbox, through which an external power source is connected for power input. The parallel reduction gearbox is connected to the crankshaft for power output.

A crankshaft support 12 is disposed at the bottom of the crankcase, which is used to support the crankcase. A crosshead support 13 is disposed at the bottom of the crosshead case, which is used to support the crosshead case. A hydraulic support 14 is disposed at the bottom of the spacer frame, which is used to support the hydraulic end assembly 9. The multi-point support design of the crankcase, the crosshead case and the hydraulic end assembly 9 can enhance the support strength of the five cylinder plunger pump and reduce the vibration, thus better ensuring high load operation and more smoothly running.

The operating principle of the plunger pump 5: An external power or rotating speed is transferred through the driving flange 10 to drive the reduction gearbox assembly 8 to rotate. Power and torque are transferred to the crankshaft through the two-stage speed shifting of the planetary reduction gearbox and the parallel reduction gearbox. The crankshaft rotates within the power end housing 11, driving the motion of the connecting rod, the crosshead and the pull rod, converting the rotational motion of the crankshaft into the reciprocating linear motion of the pull rod. The pull rod drives the plunger through a clamp to move back and forth within the valve housing, thus realizing the low pressure liquid suction and high pressure liquid discharge, i.e, realizing the pumping of liquid.

The operating principle of the single-motor single-pump electric drive fracturing semi-trailer: an input end of the high voltage switch is connected to the high voltage power supply through a cable, an output end of the high voltage switch is connected to the transformer. The high voltage switch is configured to control the power supply on and off of the whole single-motor single-pump electric drive fracturing semi-trailer. High voltage electricity is dropped by a transformer to supply power to the frequency converter, the frequency converter drives the electric motor 4 to work, and the electric motor 4 drives the plunger pump 5 to work. The radiator 6 cools the lubricating oil of the plunger pump 5.

It will be appreciated to persons skilled in the art that the present invention is not limited to the foregoing embodiments, which together with the context described in the specification are only used to illustrate the principle of the present invention. Various changes and improvements may be made to the present invention without departing from the spirit and scope of the present invention. All these changes and improvements shall fall within the protection scope of the present invention. The protection scope of the present invention is defined by the appended claims and equivalents thereof.

1. A single-motor single-pump electric drive fracturing semi-trailer, comprising a semi-trailer body, a plunger pump, a radiator, a power supply unit and an electric motor, the power supply unit, the electric motor, the radiator and the plunger pump are installed on the semi-trailer body, there are one electric motor, one radiator, and one plunger pump, the power supply unit supplies power to the electric motor, the electric motor is connected to the plunger pump, the radiator cools lubricating oil of the plunger pump; and
wherein the plunger pump is a five cylinder plunger pump which comprises a power end assembly, a hydraulic end assembly and a reduction gearbox assembly, one end of the power end assembly is connected to the hydraulic end assembly, the other end of the power end assembly is connected to the reduction gearbox assembly, the power end assembly comprises a crankcase, a crosshead case and a spacer frame which are connected in sequence; and
wherein the plunger pump has five plungers, and a distance between central axes of every two adjacent plungers is 13-14 inches.

2. The single-motor single-pump electric drive fracturing semi-trailer according to claim 1, wherein the power supply unit comprises a voltage conversion unit and a frequency conversion unit, the frequency conversion unit is connected to the voltage conversion unit, the voltage conversion unit is disposed at one end of the semi-trailer body near the electric motor, and the frequency conversion unit is disposed on a gooseneck of the semi-trailer body.

3. The single-motor single-pump electric drive fracturing semi-trailer according to claim 2, wherein the voltage conversion unit has a cabin structure with multiple compartments, in which switch and a transformer are arranged, and the switch is connected to the transformer.

4. The single-motor single-pump electric drive fracturing semi-trailer according to claim 2, wherein the frequency conversion unit has a cabin structure with multiple compartments, in which a frequency converter is arranged, an input end of the frequency converter is connected to the voltage conversion unit, an output end of the frequency converter is connected to the electric motor.

5. (canceled)

6. The single-motor single-pump electric drive fracturing semi-trailer according to claim 1, wherein the five cylinder plunger pump has a stroke of at least 10 inches.

7. The single-motor single-pump electric drive fracturing semi-trailer according to claim 1, wherein the five cylinder plunger pump has a power of at least 5000 hp.

8. The single-motor single-pump electric drive fracturing semi-trailer according to claim 7, wherein the five cylinder plunger pump has a power of about 7000 hp.

9. (canceled)

10. The single-motor single-pump electric drive fracturing semi-trailer according to claim 1, wherein the crankcase and the crosshead case are welded to constitute a power end housing which is connected to the spacer frame, the power end housing comprises six vertical plates, six bearing seats, a front end plate, a back cover plate, a base plate, a support plate and an upper cover plate; each vertical plate is connected to a corresponding bearing seat, and the six vertical plates are arranged in parallel to constitute a power end chamber; the base plate is mounted at a bottom of the power end chamber, the upper cover plate is mounted on a top of the power end chamber, the front end plate is mounted at a front end of the power end chamber, the back cover plate is mounted at a back end of the power end chamber, and the support plate is disposed between two adjacent vertical plates arranged in parallel.

11. The single-motor single-pump electric drive fracturing semi-trailer according to claim 1, wherein a crankshaft support is disposed at the bottom of the crankcase, and the crankshaft support is used for supporting the crankcase.

12. The single-motor single-pump electric drive fracturing semi-trailer according to claim 1, wherein a crosshead support is disposed at the bottom of the crosshead case, and the crosshead support is used for supporting the crosshead case.

13. The single-motor single-pump electric drive fracturing semi-trailer according to claim 1, wherein a hydraulic support is disposed at the bottom of the spacer frame, and the hydraulic support is used for supporting the hydraulic end assembly.
